(19) United States
(12) Patent Application Publication
(10) Pub. No.: US 2026/0196863 A1
(43) Pub. Date: Jul. 9, 2026

(54) NETWORK SWITCH PORT SHED

(71) Applicant: Genoa PCM, LLC, Saunderstown, RI (US)

(72) Inventor: Daniel A. Davis, III, Saunderstown, RI (US)

(21) Appl. No.: 19/538,146

(22) Filed: Feb. 12, 2026

Related U.S. Application Data
(63) Continuation of application No. 19/408,518, filed on Dec. 4, 2025.
(60) Provisional application No. 63/741,795, filed on Jan. 3, 2025.

(51) Int. Cl. H02J 9/06; H02J 13/12

(52) U.S. Cl. CPC H02J 9/06; H02J 13/12

(57) ABSTRACT

An intelligent power-management system for Power Sourcing Equipment (PSE) such as network switches operating on backup power supplied by an uninterruptible power supply (UPS). When utility power is lost, the system monitors the operational status of the UPS and dynamically controls individual network switch ports according to assigned priority levels. By deactivating lower-priority ports in a staged sequence as battery capacity declines, the system preserves power for critical network-connected devices and extends overall UPS runtime. Priority assignments may be user-defined or determined autonomously through artificial intelligence, environmental sensing, security inputs, or real-time network behavior. The system further incorporates predictive battery-runtime modeling, adaptive threshold adjustment, and integration with external building-management and emergency-response systems. Through coordinated control logic and continuous UPS telemetry monitoring, the system improves the resilience, efficiency, and operational continuity of modern PoE-enabled network infrastructures during utility outages.

### CROSS-REFERENCE TO RELATED APPLICATIONS

This application is a continuation of U.S. patent application Ser. No. 19/408,518, filed Dec. 4, 2025, which claims priority to U.S. Provisional Patent Application No. 63/741,795, filed Jan. 3, 2025, each entitled “Network Switch Port Shed,” the disclosures of which are expressly incorporated herein by reference in their entireties.

### BACKGROUND

In general, a network switch is a multiport hardware device that connects multiple devices within a local area network (LAN), enabling them to communicate with each other by intelligently forwarding data packets only to the intended recipient, essentially acting as a traffic controller for network data flow between connected devices like computers, servers, and printers. Network switches are often paired with uninterruptible power supply (UPS) devices that provide backup power to the network switches in the event of a power outage. Therefore, UPSs can help protect equipment from damage and data loss.

In traditional networks, when a network switch loses power, the UPS provides backup power. Ultimately, when the UPS loses its power, all devices linked to the ports of a network switch lose power.

### SUMMARY

The following presents a simplified summary of the innovation in order to provide a basic understanding of some aspects of the disclosure. This summary is not an extensive overview of the disclosure. It is intended to neither identify key or critical elements of the disclosure nor delineate the scope of the disclosure. Its sole purpose is to present some concepts of the disclosure in a simplified form as a prelude to the more detailed description that is presented later.

In an aspect, a method of operating a power-sourcing network device during a loss of utility power is described. The method may include providing a network switch having a plurality of individually controllable Power over Ethernet (PoE) ports configured to supply power to a plurality of powered network devices; supplying operating power to the network switch from a primary power source connected to a battery backup unit during normal operation; supplying backup power to the network switch from the battery backup unit upon loss of power from the primary power source; storing, in a memory of the network switch, a respective shutdown threshold associated with each of the plurality of PoE ports, each shutdown threshold corresponding to a battery state of the battery backup unit; monitoring, by processing circuitry of the network switch, a battery state of the battery backup unit while the battery backup unit is supplying backup power to the network switch; and selectively disabling, by the processing circuitry, one or more of the plurality of PoE ports when the monitored battery state reaches the shutdown threshold associated with the one or more PoE ports so as to reduce electrical load on the battery backup unit while maintaining power to remaining PoE ports. Non-transitory computer readable media containing computer-executable instructions to perform a similar method is described.

In another aspect, a power-management system for network port shedding is described. The system may include Power Sourcing Equipment (PSE) that includes a plurality of PoE-capable ports each configured to supply electrical power and data connectivity to a respective powered network device, processing circuitry, and a memory for storing port-priority data and associated shutdown thresholds for the plurality of PoE-capable ports; a battery backup unit configured to supply backup power to the PSE upon loss of power from the primary power source and to communicate battery-state information to the processing circuitry; and a primary power source coupled to the battery backup unit. The processing circuitry may be configured to monitor the battery-state information from the battery backup unit while the PSE is operating on backup power, and in response to the battery-state information reaching the shutdown threshold associated with a first subset of the PoE-capable ports, disable the first subset of the PoE-capable ports while maintaining power to a second subset of the PoE-capable ports having higher priority.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

These and other features, aspects, and advantages of the present disclosure will become better understood with reference to the following description, appended claims, and accompanying drawings where:

FIG. 1 is a block diagram of example system components in accordance with aspects of the present disclosure;

FIG. 2 is a flow diagram of example operations in accordance with aspects of the disclosure; and

FIGS. 3-8 are example user interfaces associated with a configurator tool in accordance with aspects of the present disclosure.

### DESCRIPTION OF THE DISCLOSURE

The subject innovation is now described. In the following description, for purposes of explanation, numerous specific details are set forth in order to provide a thorough understanding of the present disclosure. It may be evident, however, that the present disclosure may be practiced without these specific details. In other instances, well-known structures and devices are shown in block diagram form in order to facilitate describing the present disclosure.

The present disclosure is directed to an apparatus and method that turns off (i.e., port sheds) specific ports of a network switch when an uninterruptible power supply (UPS) communicates on battery backup with a goal of keeping critical ports running longer than the original UPS basis of design. The present disclosure provides improvements to UPS technology for use with network switches. Specifically, a network switch turns off specific ports (“port shedding”) based on priority when the UPS communicates it is operating on battery backup. The port shedding can also be initiated on a predetermined schedule. One goal is to keep critical ports running longer.

The present disclosure may include software (e.g., artificial intelligence (AI)) that enables users to prioritize the network switch ports connected to critical systems and equipment (e.g., security cameras, door locks, specific lights, critical apps) being supported by the UPS, so that power is maintained to the critical systems as long as possible.

Shedding specific network switch ports lowers the load on the UPS and provides more UPS runtime. For example, users can designate certain switch ports as having “critical,” “moderate,” or “low” priority. During a power outage, the software monitors the status of the UPS battery and at user set thresholds (or AI decisions), the UPS powers down switch ports by priority to conserve battery charge. Low priority systems are powered down first. As the battery charge continues to deplete and the next threshold is reached, the moderate priority switch ports are powered down by the UPS to continue support of the critical systems for a longer period of time. Once utility (i.e., source) power is restored, the powered down ports can be automatically powered up.

In some implementations, a multi-stage, graduated shedding sequence may be provided, where stage 1 is full-power operation, stage 2 begins shedding of lowest-priority devices, stage 3 begins shedding of medium-priority devices through stage N which is a critical-only mode that continues until UPS shutdown. The multistage operation may include a configurable number of stages, a configurable thresholds per stage, notifications during each stage, and automatic reconfiguration based on real-time power usage.

In accordance with aspects of the present disclosure, Power Sourcing Equipment (PSE) are provided within a network infrastructure. PSE are device(s) that deliver electrical power to connected powered devices (PDs) over Ethernet cabling in accordance with IEEE 802.3 Power over Ethernet standards, while simultaneously transmitting and/or receiving data signals over the same cabling. PSE devices enable powered devices to receive both data connectivity and electrical power through a single Ethernet cable connection, eliminating the need for separate AC power supplies or electrical outlets at device installation locations.

PSE includes, but is not limited to, Network switches with PoE capability (endspan PSE) that combine data switching operations with PoE power delivery, Network routers with PoE capability that combine routing operations with PoE power delivery, PoE midspans or injectors that add PoE capability to existing network infrastructure by injecting power between non-PoE switches/routers and powered devices, and other network infrastructure devices incorporating integrated PSE functionality for delivering power to connected Ethernet devices.

The PSE may include operational characteristics to determine a total PoE power budget, which is the maximum aggregate electrical power available for delivery to all connected powered devices across all PoE-capable ports, limited by power supply capacity and thermal design constraints. The PSE may further determine a per-port power capability, which is a maximum electrical power each individual port can deliver to a connected powered device, determined by IEEE standard compliance (e.g., 15.4 W, 30 W, 60 W, or 90 W). The PSE may provide a power allocation methodology by which available PoE power budget is distributed among active ports, which may include static allocation, dynamic allocation, or priority-based allocation schemes.

The PSE exhibit power consumption characteristics such a base load power which is the electrical power required for the PSE device's core operations (data forwarding, routing, processing, port interface electronics) independent of PoE power delivery to connected devices. The PSE may also provide for variable load power, which is additional electrical power required to supply connected powered devices through active PoE ports, wherein the total variable load is the sum of individual per-port PoE power consumption plus power conversion losses. The PSE may provide per-port power characteristics where each PoE-capable port's power consumption can be individually determined based on the power classification of the connected powered device and port operational state.

The PSE provides capability for independent port control, allowing each PoE-capable port to be individually enabled, disabled, or configured through management interfaces, control protocols, or programmatic commands. The PSE supports dynamic port reconfiguration during operation, allowing modification of individual port states (enabled/disabled) without disrupting other active ports or requiring complete system restart. The PSE may further support logical grouping of ports into categories or assignment of priority levels to individual ports for management and operational control purposes, enabling differential treatment of ports based on criticality or importance of connected devices. The PSE may perform PoE device detection and classification on each port to identify the presence of compliant powered devices and determine their power requirements before initiating power delivery, preventing power delivery to non-PoE devices that could be damaged by applied power.

The PSE circuitry may include device detection and classification modules, power-allocation logic, and per-port current-limiting components configured to supply controlled electrical power to connected powered devices.

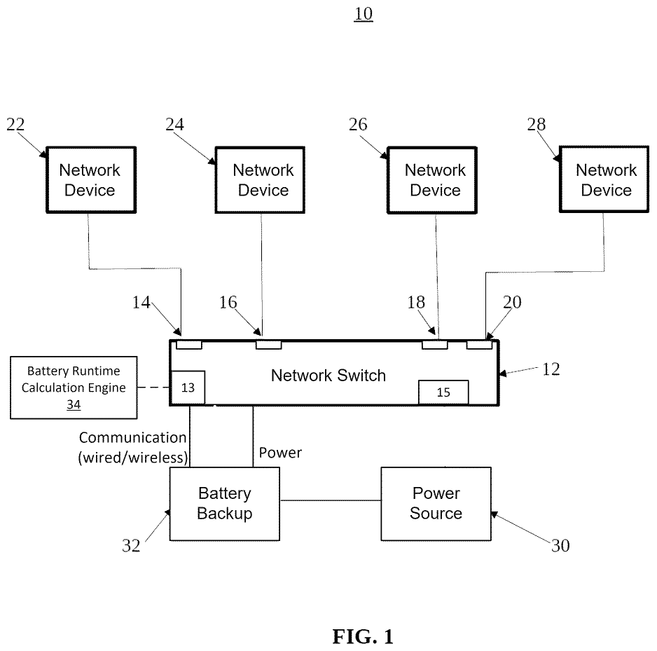

Referring now to FIG. 1, an exemplary network 10 includes a network switch 12. In this one example, the network switch 12 includes four ports 14, 16, 18, 20. Other network switches may include more or fewer ports connecting more or fewer network devices. The four ports 14, 16, 18, 20 are linked to, as well as provide power over Ethernet (PoE) to, respective network devices 22, 24, 26, 28. The link may be wired or wireless. In this example, network device 22 is an access control device, network device 24 is a camera, network device 26 is a scanner and network device 28 is telephonic equipment. Each networked device 22, 24, 26, 28 connected to the network switch 12 can be identified by its network address. The network switch 12 may include a communications interface 13, which may be wired or wireless. In some implementations, the network switch 12 includes an integrated battery runtime calculation engine 15 and/or optionally communicates with an external battery runtime calculation engine 34 via the communications interface 13, as described below.

The network switch 12 is a multiport data communication device configured to interconnect a plurality of network devices within a local area network and to selectively forward data packets between the devices. The network switch 12 operates at the data link layer and includes hardware and control logic for receiving Ethernet frames on individual ports, evaluating destination addressing information, and forwarding the frames to output ports associated with the intended destination devices.

In one embodiment, the network switch 12 includes a plurality of physical Ethernet ports, such as ports 14, 16, 18, and 20. Each port includes physical-layer transceiver circuitry, media access control (MAC) layer logic, and port-specific control circuitry. Each port is independently controllable, and each port can be selectively enabled, disabled, or reconfigured without interrupting the operation of the remaining ports. The ports are configured to support both data transmission and, in some embodiments, Power over Ethernet (PoE) delivery to connected powered devices. PoE delivery may be provided in accordance with IEEE 802.3af, 802.3at, or 802.3bt standards, thereby enabling individual ports to deliver regulated DC power levels sufficient to support devices having power classifications from Class 0 through Class 8.

The network switch 12 further includes a switching fabric or backplane providing an internal high-speed data path between the ports. The switching fabric supports simultaneous packet transfers among multiple ports and includes forwarding logic for maintaining and updating a MAC address table that associates destination MAC addresses with corresponding output ports.

Processing circuitry within the network switch 12 includes at least one processor, memory devices, and control logic configured to manage packet forwarding operations, monitor port states, maintain priority assignments, and execute port-shedding control routines. Memory associated with the processor stores configuration data including user-assigned port priorities, battery threshold values, MAC address table entries, and operational parameters used during battery-backup events.

The network switch 12 further includes power supply circuitry that receives electrical energy from a primary power source and converts the energy to operating voltages required by internal components. When PoE capability is present, the switch includes power PSE circuitry associated with the PoE-capable ports, as described above. The network switch 12 includes management interfaces configured to allow configuration and monitoring of port states, PoE delivery, priority assignments, port-shedding thresholds, and operational parameters. The management interfaces may include one or more of a graphical user interface, command-line interface, network management protocol interface, or application programming interface.

In some implementations, the switch 12 may be network router with PoE capabilities (e.g., a PSE device). Routers include PoE-capable ports alongside routing functionality. They operate as PSE devices similar to the network switch 12 but include routing/gateway functions. Examples include, but are not limited to, small business routers with 4-8 PoE ports, edge routers with PoE for connecting APs or cameras, and integrated switch/router devices. It is noted that a router with PoE ports is functionally similar to the switch 12 from a port shedding perspective and it has controllable ports that consume UPS power and supply PoE to devices.

The network router may include multiple physical network ports including WAN (wide area network) ports for upstream connectivity and LAN (local area network) ports for downstream device connectivity, wherein one or more LAN ports incorporate PoE capability. The network router may include switching fabric (for multi-port LAN configurations) that provides internal data paths between LAN ports and between LAN and WAN interfaces. Similar to the network switch 12, the network router may include management interfaces for configuration, monitoring, and dynamic reconfiguration of routing parameters, port states, and operational parameters. The network router performs routing functions including network address translation (NAT), firewall operations, DHCP server operations, VPN termination, and other gateway services, while simultaneously operating as a PSE for PoE-enabled LAN ports.

During loss of power from the primary power source, the network switch 12 operates in conjunction with a battery backup unit 32 (described below). The network switch 12 receives information indicating that the battery backup unit has entered a battery-discharge mode. In response, the processing circuitry initiates port-shedding operations. Each port of the network switch 12 is associated with a predetermined shutdown threshold, which may correspond to battery charge percentage levels or other battery-state metrics. The thresholds determine the sequence in which ports are powered down as the battery discharges.

In operation, the processor monitors the state of charge of the battery backup unit. When the battery state of charge decreases below the highest port-shedding threshold, the processor disables the corresponding low-priority port, thereby removing the data load and PoE load drawn by the connected device. As battery discharge continues and subsequent thresholds are reached, the processor disables additional ports in accordance with their assigned priorities. High-priority ports remain energized for a longer duration, thereby preserving network connectivity for critical equipment during power-loss conditions. When power from the primary power source is restored, the network switch 12 automatically restores power to any previously disabled ports and resumes normal operation.

In certain embodiments, artificial intelligence (AI) or rule-based algorithms are implemented within the network switch 12 to determine port-shedding priorities, adjust port-shedding thresholds, or initiate port-shedding based on user-defined schedules, operational patterns, or learned behaviors. The AI system may analyze historical power events, device usage patterns, or load characteristics to optimize port-shedding sequences and extend operational runtime during battery-backup events.

In accordance with certain implementations, the port priorities may be determined based on one or more of the following criteria in addition or in combination with a designated priority. Such criteria may include environmental and sensor-based inputs for occupancy detection (motion sensors, access control events), room or zone occupancy mapping, environmental factors (temperature, humidity, air quality), time-of-day schedules and integration with calendars and facility schedules. Other criteria may include security-based inputs, such as physical security system events, cybersecurity threat response (e.g., isolating compromised ports), emergency protocol activation, compliance-based priority adjustments, and dynamic Real-Time Inputs. Yet other criteria may include 0er-port power consumption monitoring that includes real-time traffic volume analysis, QoS (quality of service) metrics, active-session monitoring of connected devices, SOC/NOC override capabilities, and integration with emergency alert systems. Yet further criteria may include feedback loop inputs, such as building management system (BMS) status, utility restoration prediction, generator start/availability monitoring, and external emergency coordination systems.

The integrated port-shedding capability of the network switch 12 reduces overall load on the battery backup unit, thereby extending the runtime available for critical network devices. The capability also enables reduction in required UPS size and battery capacity in certain installations, thereby reducing capital and operational costs while improving resilience and ensuring continued operation of essential systems such as access control devices, security cameras, communication devices, or other critical infrastructure components.

In yet other implementations, devices such as a Single-Port PoE Injector, PoE extender and/or a Wireless Access Point with PoE pass-through may be controlled similarly as the network switch 12 to perform port shedding. Single-port PoE injectors are devices with one data-in port and one data+power-out port. PoE extenders receive PoE power, regenerate/boost it, and extend to another device. Typically, PoE extenders sit in the power path and consume power from the UPS. Wireless Access Point with PoE Pass-through can receive PoE on one port and provide PoE output on another port. They are both PD (powered device) and PSE (power sourcing equipment) simultaneously.

The battery runtime calculation engine 15 may be provided to determine a runtime of the battery backup unit 32 in real-time. The battery runtime calculation engine 15 determines a runtime of the battery backup unit 32 by accounting for one or more of battery chemistries (VRLA, Li-Ion, solid-state, etc.), aging and health factors, extended battery modules, and discharge efficiency curves. The battery runtime calculation engine 15 dynamically recalculates projected runtime during an event and adjusts shedding thresholds automatically based on observed load. The battery runtime calculation engine 15 may employ machine learning to refine future predictions. Such machine learning may provide for autonomous learning for threshold optimization. In some implementations, the external battery runtime calculation engine 34 may be provided to perform the operations above in addition or, or in place of, the battery runtime calculation engine 15.

The network 10 also includes a primary power source 30 and a battery backup unit 32. The primary power source 30 provides power to the battery backup unit 32, which in turn powers the network switch 12. In this example, the battery backup unit 32 is an uninterruptible power supply (UPS). Upon loss of power from the primary power source 30, the battery backup unit 32 continues power to the network switch 12 using its battery as a power source, thus continuing power to the network devices 22, 24, 26, 28. The battery backup unit 32 includes power conversion circuitry, energy storage components, and wired or wireless communication interfaces to connect to the communication interface 13 enabling the network switch 12 to monitor battery operating conditions and initiate port shedding operations to extend system runtime. The communication interface 13 may also enable communications from the battery backup unit 32 to the LAN and/or a WAN connection to connect to a cloud server, as described below.

Port shedding may be initiated in response to hardware-based control or software-based protocols and control. The hardware-based control may be based on smart PDUs, relay-based switching, network-controlled circuit breakers, and direct port power regulation via hardware interfaces. Software/protocol control may include SNMP-based PoE control, REST API commands, CLI scripting, SDN (software-defined networking) integration and other proprietary UPS or switch protocols.

In one embodiment, the battery backup unit 32 includes an AC input stage configured to receive utility power from the primary power source 30. The AC input stage is coupled to rectification and regulation circuitry that supplies charging current to one or more rechargeable batteries. The battery backup unit 32 further includes an inverter stage configured to provide regulated AC output power to the network switch 12. Upon loss of AC input power, the battery backup unit 32 automatically transfers to battery operation without interruption in output power.

The battery backup unit 32 monitors operational parameters including, but not limited to: state of charge (SOC); remaining runtime; battery voltage and current; battery temperature; output load in watts or volt-amperes (VA); and alarm states and fault conditions. These parameters are made available to the network switch 12 through one or more communication channels as described below.

The battery backup unit 32 may include any suitable interface enabling communication with the network switch 12. One example may be a Network Management Card (NMC) supporting Ethernet connectivity and protocols such as SNMP, HTTP/HTTPS, SSH, Telnet, or proprietary protocols. The UPS network management card provides monitoring capabilities enabling remote observation of UPS operational status including, but not limited to, battery state parameters including state of charge (SOC), remaining capacity, battery voltage, battery temperature, and estimated remaining runtime; power parameters including input voltage, input frequency, output voltage, output frequency, output current, load power (watts or VA), and load percentage; operational status including power source (utility/battery), alarm conditions, fault states, and operational mode; and historical data including event logs, alarm history, power quality events, and battery test results.

The UPS network management card provides control capabilities enabling remote execution of commands and operational changes including, but not limited to, load management commands including load segment disconnection, outlet group control, or complete load shutdown; UPS operational commands including battery self-test initiation, operational mode changes, or controlled UPS shutdown; configuration commands including parameter adjustments, threshold settings, and notification configurations and scheduled operations including time-based actions, calendar-based routines, or conditional command execution. The UPS network management card may enable automated monitoring wherein external systems periodically query UPS status parameters without human intervention; automated control wherein external systems issue commands to the UPS based on monitoring data, logical conditions, or predetermined algorithms; scripting capabilities allowing execution of command sequences, conditional logic, or multi-step operations; and event-driven actions wherein the network card can initiate commands based on detected conditions or threshold violations.

Another example may be a cloud-connected communication card configured to establish outbound encrypted connections (e.g., HTTPS, TLS, MQTT) to cloud servers for remote monitoring and command relay. A cloud-connected UPS network management card may include network interface hardware, processing circuitry, UPS interface circuitry providing electrical and protocol connectivity to the host UPS internal systems, enabling bidirectional communication between the network card and UPS control systems. The cloud-connected UPS network management card may initiate outbound connections from the local installation to remote cloud servers to continuously or periodically transmit UPS operational data to cloud servers for storage, analysis, and presentation. Remote users or systems may access UPS information by connecting to cloud service web portals, mobile applications, or APIs rather than directly accessing the network card. Control commands may be relayed from cloud services to the network card through established communication channels, enabling remote UPS control from any internet-connected location.

The cloud-connected UPS network management card provides monitoring capabilities through cloud service interfaces. Such monitoring may include real-time status monitoring of battery state parameters (state of charge, remaining capacity, voltage, temperature, estimated runtime), power parameters (input/output voltage, frequency, load power, load percentage), and operational status (power source, alarms, faults); historical data access including long-term trend data, event logs, alarm history, power quality records, and battery performance metrics stored on cloud servers.

The cloud-connected UPS network management card provides control capabilities through cloud service interfaces enabling remote execution of commands such as load management commands including load segment disconnection, outlet group control, or complete load shutdown; UPS operational commands including battery self-test initiation, operational mode changes, or controlled UPS shutdown; configuration commands including parameter adjustments, threshold settings, and notification configurations; and scheduled operations configured through cloud interfaces and executed by the network card at designated times or conditions.

The cloud-connected UPS network management card supports programmatic access through cloud service APIs (Application Programming Interfaces) enabling features such as automated monitoring wherein external applications query UPS status through cloud service API endpoints; automated control wherein external applications issue commands to UPS units through cloud service API calls; third-party integration allowing custom applications, network management systems, or automation platforms to interact with UPS units through documented cloud APIs; and event-driven automation wherein cloud services can trigger actions based on UPS status conditions, threshold violations, or complex rule evaluations.

The cloud-connected UPS network management card may provide external device control capabilities wherein control commands issued through cloud services can be relayed to connected network equipment enabling the cloud service to orchestrate actions involving both the UPS and connected powered devices; trigger automated responses in other cloud-connected systems or services through API integrations or webhook notifications; and execute multi-device coordination wherein a single cloud-based command initiates actions across multiple UPS units and connected infrastructure.

The cloud-connected UPS network management card supports enhanced notification capabilities leveraging cloud infrastructure including, but not limited to, push notifications to mobile devices for immediate alert delivery, e-mail and SMS notifications generated by cloud services based on UPS status; webhook notifications enabling cloud services to trigger external automation systems or applications; and scalation procedures wherein cloud services implement multi-level notification based on alarm severity or response delays.

Yet another example may be one or more wireless communication interfaces such as Bluetooth or NFC for short-range provisioning, status retrieval, or command execution. The Bluetooth interface may enable wireless monitoring of UPS status from nearby devices, sending port shedding commands to switches/routers without network infrastructure, mobile app control of shedding operations, and pairing configuration devices with infrastructure equipment. NFC may enable simplified configuration by tapping a phone against equipment, authentication for issuing control commands, emergency manual override by tapping credential tags, and quick device identification and status retrieval.

Through these interfaces, the battery backup unit 32 transmits real-time operating conditions to the network switch 12. The network switch 12 reads such data to determine when one or more preconfigured thresholds have been reached and when specific ports should be powered down.

The battery backup unit 32 may further support control functions including remote load management, battery self-test initiation, configuration changes, alarm acknowledgement, and scheduled operational commands. In certain embodiments, the battery backup unit 32 supports event-driven automation in which predefined conditions—such as low battery thresholds, fault detection, or cloud-based rules—trigger automatic communication of status information to the network switch 12.

During a loss of utility power, the battery backup unit 32 supplies power to the network switch 12 and concurrently transmits battery parameters. The network switch 12 compares the received battery status to user-defined or AI-determined thresholds associated with respective switch ports, as described below. When a threshold is met or exceeded, the network switch 12 disables the corresponding port(s) to reduce the electrical load on the battery backup unit 32, thereby extending the battery runtime available to support critical network devices.

In one embodiment, ports designated as “low priority” are disabled when the battery state of charge falls below a first threshold, ports designated as “moderate priority” are disabled when the battery state of charge falls below a second threshold, and ports designated as “critical priority” remain enabled until a lower threshold is reached. Reducing load on the battery backup unit 32 increases its effective runtime and allows critical devices—such as security systems, access control devices, and life-safety applications—to remain operational for a longer duration.

The battery backup unit 32 may include security features such as role-based access control, credential authentication, encrypted communication channels, and secure boot functionality. The battery backup unit 32 may also include contact closures, relay outputs, or digital I/O capable of triggering external systems during a power event. In some implementations, NFC interfaces enable rapid configuration or manual override commands through physical proximity authentication.

In any network, such as network 10, certain network devices are more critical than others. This is particularly the case when power is lost from the primary power source 30 and then powered by the battery backup unit 32. In one implementation, the network switch 12 is configured to perform network port shedding based on a user set threshold (i.e., designation or priority) to each of the network devices 22, 24, 26, 28. For example network device 22 may be designated “critical,” network devices 24, 26 may be designated “moderate,” and network device 28 may be designated “low.”

Network port shedding enables a user to make predetermined and/or AI decisions on which ports 14, 16, 18, 20 are most critical in the event of a power outage (e.g., security cameras, critical apps, door locks, specific lights and so forth.

User set thresholds are stored in the network switch 12. In one implementation, the set thresholds are battery percentage levels in the battery backup unit 32. For example, network device 22 may be assigned a set threshold of 50% charge, network devices 24, 26 may be assigned set thresholds of 70% charge and network device 28 may be assigned a set threshold of 85% charge.

In this example, when power is lost from the primary power source 30 and the battery backup unit 32 takes over, the network switch 12 monitors the battery level of the battery backup unit 32. As the power levels drop in the battery backup unit 32, the network switch 12 port sheds (i.e., terminates power to) one or more of the network devices 22, 24, 26, 28 according to their pre-configured user set thresholds. More specifically, when the battery in the battery backup unit 32 drops below 85%, the network device 12 turns off power to port 20. When the battery in the battery backup unit 32 drops below 70%, the network device 12 turns off power to ports 16 and 18. And when the battery backup unit 32 drops below 50%, the network device 12 turns off power to port 14. Shedding or shutting off the network port lowers the load on the UPS and provides more UPS runtime over an original basis of design.

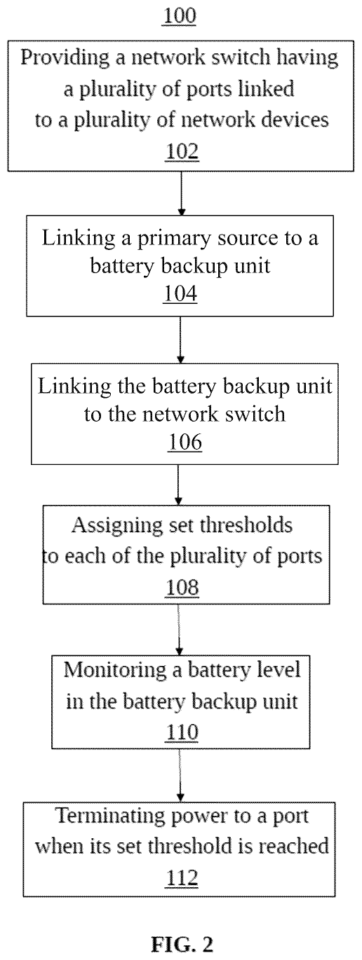

With reference to FIG. 2, there is illustrated and example process 100 in accordance with the present disclosure to perform port shedding. Process 100 includes linking (104) a primary power source to a battery backup unit. Process 100 includes linking (106) the battery backup unit to the network switch. Process 100 includes assigning (108) set thresholds to each of the plurality of ports. Process 100 includes monitoring (110) a battery level in the battery backup unit. Process 100 includes terminating (112) power to a port when its set threshold is reached.

In summary, if the UPS were to lose power, the network switch monitors the status of the local UPS. At user set thresholds, the network switch powers down specified non-critical ports. By powering down non-critical ports, the network switch is able to operate a client's critical loads for longer. Once utility power is restored, the suspended outlets (i.e., ports) automatically power up.

Network switch port shedding on a predetermined schedule and/or using AI when a UPS (Uninterruptible Power Supply) goes to its battery reserves during a power outage has several impacts. Today a UPS basis of design has a specified VA/Watt rating and a battery runtime rating (design) based on the AC load of the IT equipment being powered. In many cases, extra batteries and larger UPS's may be used to hit the basis of design UPS runtime. Since the advent of POE in network switching around the time VOIP came to the market POE (Power over Ethernet) ratification and capacity has grown.

At inception, POE could deliver 15 watts per port of −48V DC current. Today POE++ produces over 90 watts per port −48V DC. Many are starting to call this the convergence of power and data.

As the POE loads increase, so do the AC power supplies supporting them, which also increases the size and battery needs of the UPS design. When a UPS goes on battery to support the IT equipment it has a limited amount of time to provide AC current to the equipment downstream.

Network port shedding enables the customer to make predetermined and or AI decisions on which ports are most critical in the event of a power outage. Shedding or shutting off the network port lowers the load on the UPS and provides more UPS runtime over the original basis of design.

Additional benefits are that the UPS basis of design can reduce the size of the UPS and or number of batteries, reducing customer Capex and Opex. Additional benefits could be security for air gapping the port in the event of a power outage or triggering other actions (e.g. locks, and so forth).

Further, the systems and methods of the present disclosure may be embedded within firmware in switches/UPS, as an Integrated UPS and switch management module, as a standalone hardware controller, as a cloud-based supervisory service, as a network management system plugin, and as a hybrid distributed controller.

### Network Port Shedding Configurator

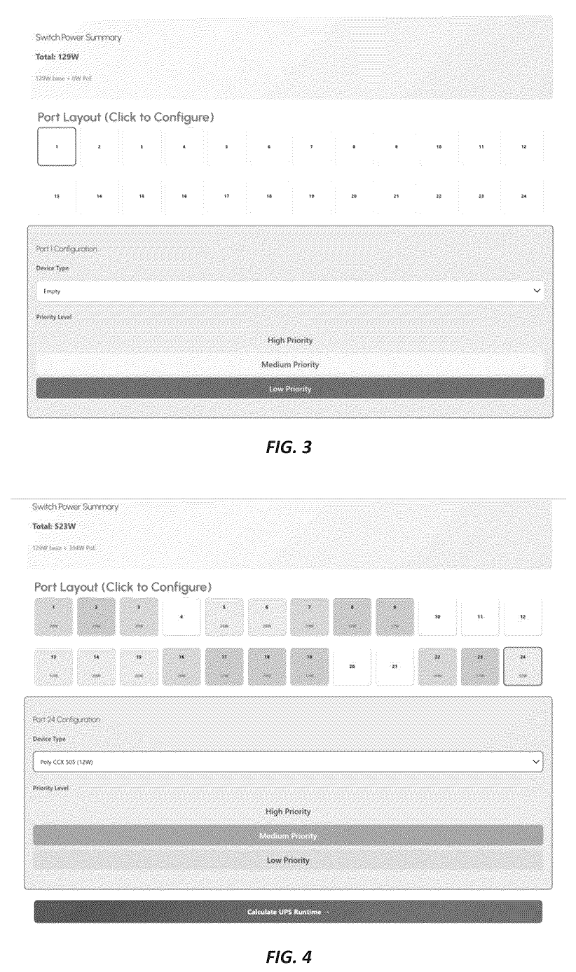

With reference to FIGS. 3-8, the Network Port Shedding (NPS) Configurator is designed as an interactive, web-based planning environment for modeling and analyzing the effects of prioritized electrical load reduction on the runtime of an Uninterruptible Power Supply (UPS) during an AC power outage. The system enables network engineers and administrators to evaluate the quantitative benefits of staged load shedding and to determine the amount of runtime extension achievable through removal of selected network-connected devices when operating on battery power.

In operation, the system models network equipment power consumption and UPS discharge behavior to provide comparative runtime analyses between single-stage and multi-stage shedding methodologies. As the user configures individual switch ports, assigns device types, and applies optional priority levels, the system continuously calculates total power consumption. The interface presents a visual representation of typical multi-port network switches and allows each port to be populated with one or more classes of connected equipment. These classes include wireless access points, VoIP telephones, IP security cameras, and network switches, each represented through standardized, technology-agnostic power consumption values derived from industry Power-over-Ethernet (PoE) standards. The calculator further enables assignment of load-shedding priority categories, such as high, medium, or low importance, thereby permitting the system to model staged disconnection events at user-defined battery thresholds.

The runtime analysis engine employs energy-based calculations that reflect the thermodynamic characteristics of battery discharge. For each stage of operation, the system computes available energy using the UPS battery's rated watt-hour capacity and the percentage of the battery intended for discharge. Stage duration is derived by dividing available energy by the instantaneous power load of the equipment assigned to that stage. The total estimated runtime is generated by summing the durations of all stages. To improve accuracy, the system uses logarithmic interpolation between manufacturer-published runtime data points, thereby reflecting the exponential discharge characteristics of UPS battery chemistry.

Example energy-based runtime calculations may include using thermodynamically accurate energy-based formulas rather than simplified linear assumptions, for example:

$$Available Energy ( Wh ) = Total Battery Capacity ( Wh ) \times Battery \% Range / 100 \\ Stage Runtime ( minutes ) = ( Available Energy ( Wh ) / Stage Power Load ( W ) ) \times 60 \\ Total Runtime = Sum of all stage runtimes$$

The system accommodates differing behaviors of VRLA and lithium-ion battery technologies, including voltage sag, depth-of-discharge characteristics, and typical manufacturer-recommended shutdown thresholds. These considerations enable more accurate modeling of real-world runtime performance, particularly where lithium-ion batteries permit deeper discharge than traditional VRLA units.

Example battery chemistry optimization may account for fundamental differences between battery technologies, such as VRLA (Valve-Regulated Lead-Acid) and Lithium Ion. VRLA may configured with a conservative discharge to 80-86% depth, characteristic voltage sag under load, and a typical shutdown at 20-30% remaining capacity. Lithium Ion may be configured with a deeper safe discharge to 85-90% depth, flatter discharge curve maintaining more consistent voltage, and a typical shutdown at 10-15% remaining capacity.

The technical architecture incorporates a device database, a battery and UPS specification database, and a priority-based classification engine. The UPS data includes battery capacity, external battery module information, maximum load ratings, and performance curves. The system is manufacturer-agnostic and avoids reliance on vendor-specific identifiers, enabling interoperability across diverse network and power systems. Priority frameworks allow the system to apply staged disconnect events triggered at configurable battery levels, such as disconnecting low-priority devices at a first threshold and medium-priority devices at a second threshold while preserving high-priority devices until the final stage of battery operation.

During typical use, a user may begin by configuring network equipment. For example, as shown in FIGS. 3 and 4, the user may select a network port or device position, assign device type from generic categories, and set a priority level (e.g., High/Medium/Low). The aforementioned steps may be repeated for all or a subset of connected devices. The configurator automatically calculates total power consumption.

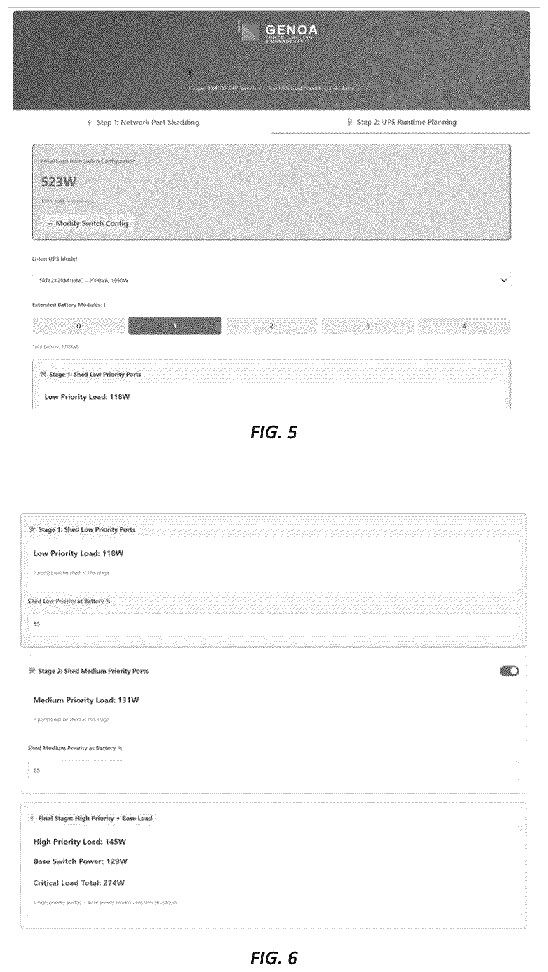

The user next performs UPS runtime planning. For example, as shown in FIGS. 5-6, the user may select the UPS model, battery configuration, and desired shedding thresholds. Example non-limiting thresholds may be stage one is 85% battery remaining, stage two is 65% battery remaining, and UPS shutdown at 10-15% remaining. The threshold may be adjusted in accordance with user preferences and/or battery chemistry.

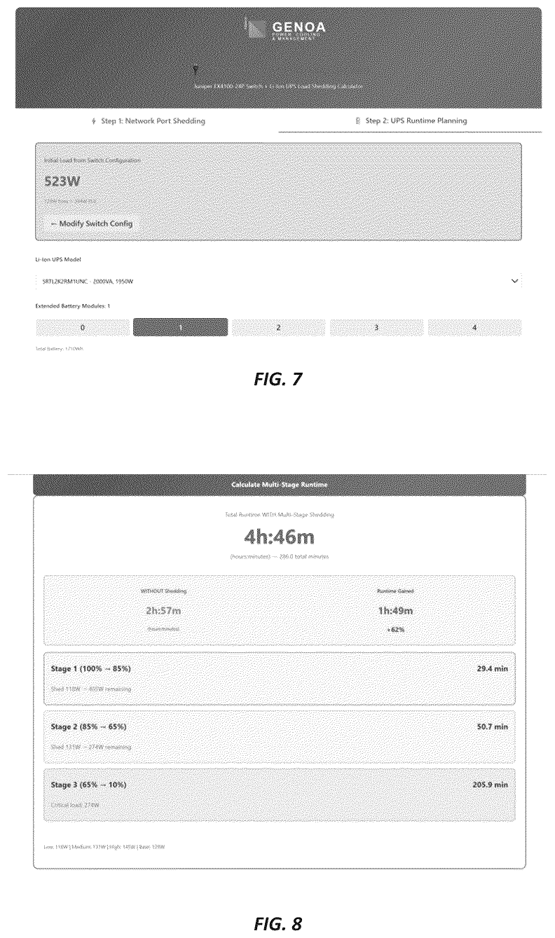

As shown in FIGS. 7-8, the system then executes the computation process, and presents a detailed runtime estimate, a comparison of runtimes with and without shedding, and a stage-by-stage breakdown of battery duration. The system also provides visual representations of staged load reduction and percentage improvements in runtime resulting from the shedding plan.

The platform is structured to support future enhancements, including data import and export features, automated parsing of network switch configuration files, generation of switch configuration outputs containing port priorities, and expanded PoE device categories supporting higher-power standards such as IEEE 802.3bt. Additional improvements may incorporate battery-age modeling, temperature-based performance adjustments, multi-UPS configurations, and real-time cost analyses associated with different shedding strategies.

The system is further designed for potential integration with network management systems (NMS) and building management systems (BMS). When integrated with an NMS, the calculator may provide manual shedding recommendations, automatic alarming upon reaching configured battery thresholds, dynamic tracking of battery degradation and device additions or changes, or fully automated execution of power-shedding events. Integration with facility systems may allow coordinated prioritization based on occupancy sensors, security systems, cooling loads, and emergency lighting requirements. Additional interoperability may support directives from security operations centers, network operations centers, emergency communications systems, or public safety infrastructure.

The design philosophy emphasizes universal compatibility through adherence to industry standards such as IEEE 802.3 PoE specifications, SNMP monitoring protocols, NETCONF or SSH-based management interfaces, and common UPS communication formats including Modbus and USB HID. The platform anticipates support for emerging battery chemistries, evolving PoE standards, and alternative power-distribution architectures.

Commercial applications for the NPS Calculator System include network infrastructure planning, construction and renovation design, capacity planning for data centers, retrofit analysis for existing deployments, optimization of battery and UPS sizing, and training for engineers and technicians. The system provides an educational visualization of power-management concepts and demonstrates the operational advantages of staged load shedding.

The underlying algorithms, including the energy-based runtime engine, priority-driven shedding logic, battery-chemistry optimization techniques, vendor-neutral device-classification model, and enterprise-integration architecture, collectively represent proprietary implementations that support and extend Genoa PCM, LLC's patented methodology for Network Port Shedding. The system's universal compatibility and enterprise-level integration capabilities constitute a novel advancement enabling dynamic, continuously optimized power-management strategies across heterogeneous network infrastructures.

### Example Use Cases

The systems and methods of the present disclosure may be used in many environments, including, but not limited to Healthcare (patient monitoring devices), Transportation (signals, communications), Utilities (grid monitoring equipment), Smart buildings (HVAC, lighting controls), Defense and deployable networks, and Event networks and temporary installations.

Expandability of the Disclosed Systems and Methods

The systems and methods disclosed herein may be adapted to be incorporated with advances in power delivery, such as, higher-wattage PoE standards beyond IEEE 802.3bt, alternate voltage rails, and wireless power delivery to network devices. The systems and methods disclosed herein may be adapted to be incorporated with battery technology advances, such as, solid-state batteries, graphene-based energy storage, hybrid supercapacitor systems, and renewable energy integration (solar, fuel cells). Yet further, the systems and methods disclosed herein may be adapted to be incorporated with networking and security advances, such as, high-speed standards (25G/40G/100G/400G), 5G/6G cellular backhaul equipment, edge computing nodes, blockchain-based audit systems, and guantum-resistant encryption.

Thus, the present disclosure provides for advantages, such as 200-400% UPS runtime extension, granular multi-tier power management, predictive battery modeling, cost saving (reduced UPS/battery size), autonomous operation without user intervention, fine-grained port-level control and compatibility with emerging standards.

It would be appreciated by those skilled in the art that various changes and modifications can be made to the illustrated embodiments without departing from the spirit of the present disclosure. All such modifications and changes are intended to be within the scope of the present disclosure except as limited by the scope of the appended claims.

What is claimed:

1. A method of operating a power-sourcing network device during a loss of utility power, the method comprising:
providing a network switch having a plurality of individually controllable Power over Ethernet (PoE) ports configured to supply power to a plurality of powered network devices;
supplying operating power to the network switch from a primary power source connected to a battery backup unit during normal operation;
supplying backup power to the network switch from the battery backup unit;
storing, in a memory of the network switch, a respective shutdown threshold associated with each of the plurality of PoE ports, each shutdown threshold corresponding to a battery state of the battery backup unit;
monitoring, by processing circuitry of the network switch upon a loss of power from the primary power source, a battery state of the battery backup unit while the battery backup unit is supplying backup power to the network switch; and
selectively disabling, by the processing circuitry, one or more of the plurality of PoE ports when the monitored battery state reaches the shutdown threshold associated with the one or more PoE ports so as to reduce electrical load on the battery backup unit while maintaining power to remaining PoE ports.

2. The method of claim 1, wherein each shutdown threshold is associated with a priority level assigned to a corresponding powered network device, and wherein selectively disabling the one or more PoE ports comprises disabling PoE ports associated with lower priority levels before PoE ports associated with higher priority levels.

3. The method of claim 2, wherein the priority levels comprise at least a low-priority level, a medium-priority level, and a critical-priority level, the method further comprising:
disabling PoE ports having the low-priority level when the battery state falls below a first percentage of remaining charge,
disabling PoE ports having the medium-priority level when the battery state falls below a second percentage of remaining charge less than the first percentage; and
disabling PoE ports having the critical-priority level when the battery state falls below a third percentage of remaining charge less than the second percentage.

4. The method of claim 1, wherein monitoring the battery state comprises receiving, via a communication interface of the network switch, telemetry data from a network-connected management card of the battery backup unit, the telemetry data including at least one of: state of charge, remaining runtime, battery voltage, battery current, or output load.

5. The method of claim 1, further comprising automatically re-enabling the disabled PoE ports when power from the primary power source is restored.

6. The method of claim 1, further comprising:
executing a battery runtime calculation engine that estimates remaining runtime of the battery backup unit based on at least the monitored battery state and a current load of the network switch; and
adjusting at least one of the shutdown thresholds based on the estimated remaining runtime.

7. The method of claim 1, wherein storing the shutdown thresholds comprises receiving, via a user interface, configuration data specifying the shutdown thresholds and priority levels for the plurality of PoE ports, and storing the configuration data in the memory.

8. The method of claim 1, further comprising analyzing historical power-event data and network-device usage patterns to automatically determine at least one of: the shutdown thresholds, a priority level of individual PoE ports, or a schedule at which port shedding is initiated during battery operation.

9. A power-management system for network port shedding, comprising:
Power Sourcing Equipment (PSE) that includes a plurality of PoE-capable ports each configured to supply electrical power and data connectivity to a respective powered network device, processing circuitry, and a memory for storing port-priority data and associated shutdown thresholds for the plurality of PoE-capable ports;
a battery backup unit configured to supply backup power to the PSE upon loss of power from the primary power source and to communicate battery-state information to the processing circuitry; and
a primary power source coupled to the battery backup unit,
wherein the processing circuitry is configured to monitor the battery-state information from the battery backup unit while the PSE is operating on backup power, and in response to the battery-state information reaching the shutdown threshold associated with a first subset of the PoE-capable ports, disable the first subset of the PoE-capable ports while maintaining power to a second subset of the PoE-capable ports having higher priority.

10. The system of claim 9, wherein the battery backup unit comprises an uninterruptible power supply including a network management card configured to communicate the battery-state information to the PSE using at least one of Simple Network Management Protocol (SNMP), HTTP/HTTPS, SSH, or a cloud-based application programming interface.

11. The system of claim 9, wherein the processing circuitry is further configured to automatically restore power to the disabled PoE-capable ports when the battery backup unit returns to utility-power operation.

12. The system of claim 9, further comprising a battery runtime calculation engine implemented by at least one of the processing circuitry of the PSE or external processing circuitry, the battery runtime calculation engine being configured to compute an estimated runtime of the battery backup unit for a given power load and to provide runtime data used by the processing circuitry to set or adjust the shutdown thresholds.

13. The system of claim 9, wherein the memory further stores a multi-stage shedding configuration defining a plurality of battery-state stages and a corresponding set of PoE-capable ports to be disabled at each stage, and wherein the processing circuitry is configured to progress through the multi-stage shedding configuration as the battery-state information indicates decreasing remaining capacity.

14. The system of claim 9, wherein the PSE comprises one of: a network switch, a network router, a PoE injector, a PoE extender, or a wireless access point with PoE pass-through, and wherein the processing circuitry is configured to control powering of at least one PoE-capable port through a control interface of the PSE.

15. The system of claim 9, wherein the processing circuitry is further configured to:
receive environmental or security inputs from one or more external systems including at least one of access-control systems, occupancy sensors, or building-management systems; and
modify at least one port priority or shutdown threshold responsive to the environmental or security inputs.

16. The system of claim 9, wherein the battery backup unit comprises a lithium-ion battery pack or a valve-regulated lead-acid battery pack, and wherein a battery runtime calculation engine applies different discharge models for different battery chemistries when determining an estimated runtime and corresponding shutdown thresholds.

17. A non-transitory computer-readable medium storing instructions that, when executed by processing circuitry of a power-sourcing network device having a plurality of PoE ports and coupled to a battery backup unit, cause the processing circuitry to perform operations comprising:
receiving configuration data defining port-priority levels and associated battery-state shutdown thresholds for respective ones of the plurality of PoE ports;
monitoring, during a loss of utility power, telemetry data from the battery backup unit indicative of a state of charge or remaining runtime of the battery backup unit;
determining, based on the telemetry data and the shutdown thresholds, which of the plurality of PoE ports are to be disabled at a given time; and
issuing port-control commands to disable at least one PoE port and maintain power to at least one other PoE port so as to extend available runtime of the battery backup unit for powered devices connected to higher-priority PoE ports.

18. The non-transitory computer-readable medium of claim 17, wherein the instructions further cause the processing circuitry to:
compute, using an energy-based runtime model, an estimated duration of operation for each of a plurality of staged shedding levels, each stage corresponding to a different subset of enabled PoE ports; and
present, via a graphical user interface, a visual representation of the plurality of staged shedding levels and the estimated duration associated with each level.

19. The non-transitory computer-readable medium of claim 17, wherein the instructions further cause the processing circuitry to obtain the configuration data from a web-based configurator that enables a user to graphically select individual ports of a virtual representation of a network switch, assign a device type and priority level to each selected port, and transmit resulting configuration data to the power-sourcing network device.

20. The non-transitory computer-readable medium of claim 17, wherein the instructions further cause the processing circuitry to:
learn, over time, device-usage patterns, historical power-event information, or UPS-runtime outcomes; and
automatically recommend or implement modifications to at least one of the port-priority levels, the shutdown thresholds, or a shedding schedule to increase expected runtime of critical loads during future utility-power outages.
